(19) United States
(12) Patent Application Publication
(10) Pub. No.: US 2005/0283266 A1
(43) Pub. Date: Dec. 22, 2005

(54) Method and system for providing unit level traceability of semiconductor die

(76) Inventors: Gwen R. Geraci, Maricopa, AZ (US); David A. Carey, Phoenix, AZ (US); Beaudry C. Stewart, Higley, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/871,293

(22) Filed: Jun. 17, 2004

(51) Int. Cl. G06F 19/00

(52) U.S. Cl. 700/115; 700/112; 700/121

(57) ABSTRACT

Embodiments of a method and system providing unit level traceability for a number of die cut from a wafer are disclosed. According to some embodiments, readable marks are disposed on a carrier tape, and each readable mark is associated with one pocket of the carrier tape. A die placed in a pocket of the carrier tape has a corresponding wafer location, and this wafer location is correlated with the mark associated with that pocket. Other embodiments are described and claimed.

### FIELD OF THE INVENTION

The invention relates generally to the manufacture and sorting of semiconductor die and, more particularly, to a method and system for providing unit level traceability between semiconductor die and a wafer.

### BACKGROUND OF THE INVENTION

A carrier tape capable of holding a number of discrete semiconductor die may be utilized to facilitate automation and handling of these components. A typical carrier tape comprises a flexible tape having a row (or multiple rows) of evenly spaced pockets distributed along its length. Each pocket is configured to receive an individual die (or die assembly or packaged die), and a cover tape is adhered to an upper surface of the carrier tape to cover each pocket and retain the die on the carrier. The carrier tape can be wound onto a tape reel, and a row of small indexing holes may be distributed along the length of the carrier tape adjacent an edge of the tape, these indexing holes enabling movement of the carrier tape and/or tape reel by automated handing equipment.

After singulation of semiconductor die from a wafer, it may be desirable to trace each individual die back to that die's location on the wafer. The tracing of individual die back to a wafer location may be referred to as “unit level traceability.” Data correlating an individual die to a unique wafer location (e.g., X-Y coordinates) can be useful for a number of purposes, including failure analysis, process control and verification, quality assurance, etc. If the integrity of the data correlating a group of die to their respective locations on a wafer is not maintained, the ability to perform such analysis may be compromised.

As noted above, after a wafer has been cut into a number of individual die, the die may be placed on a carrier tape for ease of handling. One scheme for providing unit level traceability is to place each die in a pocket of the carrier tape in a sequential manner and without interruption. The order in which the die were picked from the diced wafer is known and, so long as the sequential ordering of the die on the carrier tape is maintained, the wafer location of any individual die can be determined from that die's position on the carrier tape. However, should a process or equipment failure occur during the loading of die onto a carrier tape, the sequential non-interrupted ordering of die on the carrier tape may be lost (e.g., because the carrier tape was advanced out of sequence and/or because a series of die were placed out of sequence). Should this sequential ordering of die on the carrier tape be lost, the integrity of the correlation data - and, hence, the unit level traceability—may, likewise, be compromised.

### BRIEF DESCRIPTION OF THE DRAWINGS

FIG. 1 is a schematic diagram illustrating an embodiment of a system providing unit level traceability.

FIG. 2A is a schematic diagram illustrating an elevation view of one embodiment of a carrier tape.

FIG. 2B is a schematic diagram illustrating a bottom view of the carrier tape of FIG. 2A.

FIG. 2C is a schematic diagram illustrating a bottom view of another embodiment of a carrier tape.

FIG. 2D is a schematic diagram illustrating a bottom view of a further embodiment of a carrier tape.

FIG. 3 is a schematic diagram illustrating an embodiment of a coordinate system for a diced wafer.

FIG. 4 is a schematic diagram illustrating an embodiment of the controller shown in FIG. 1.

FIG. 5 is a block diagram illustrating an embodiment of a method for providing unit level traceability between a number of die and a wafer.

FIG. 6 is a schematic diagram illustrating another embodiment of a system providing unit level traceability.

FIG. 7 is a block diagram illustrating another embodiment of a method for providing unit level traceability between a number of die and a wafer.

FIG. 8 is a block diagram illustrating an embodiment of a method for tracing a die to its wafer location.

### DETAILED DESCRIPTION OF THE INVENTION

Disclosed are various embodiments of a method and system that provides unit level traceability for a number of die cut from a wafer. According to some embodiments, readable marks are disposed on a carrier tape, each readable mark being associated with one pocket of the carrier tape. A die placed in a pocket of the carrier tape has a corresponding wafer location—e.g., X-Y coordinates—and this wafer location is correlated with the mark associated with that pocket. This correlation data may be saved in a database, and such data may be utilized for failure analysis, process control and verification, quality assurance, as well as other purposes.

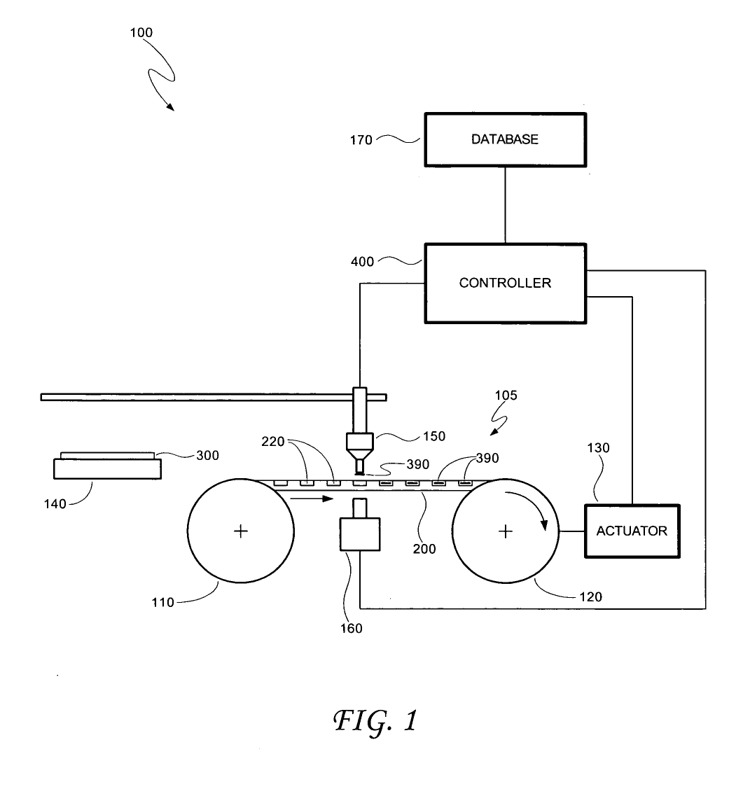

Referring to FIG. 1, illustrated is an embodiment of a system 100 which can provide unit level traceability for a number of semiconductor die that have been singulated from a wafer. System 100 includes a carrier tape mechanism 105, which comprises a source tape reel 110, a take-up reel 120, and an actuator 130 coupled with the take-up reel 120 (and/or source reel 110). Wound on the source tape reel 110 is a length of carrier tape 200 having a number of pockets 220, each pocket for receiving a die 390. Carrier tape 200 is advanced by motion of the take-up reel 120 (and/or source reel 110) initiated by actuator 130, and the carrier tape (with die 390) is wound onto the take-up reel 120. Alternatively, movement of the carrier tape 200 may be initiated by a mechanism that engages a series of indexing holes on the carrier tape itself (either alone or in combination with motion of the take-up reel 120 produced by actuator 130).

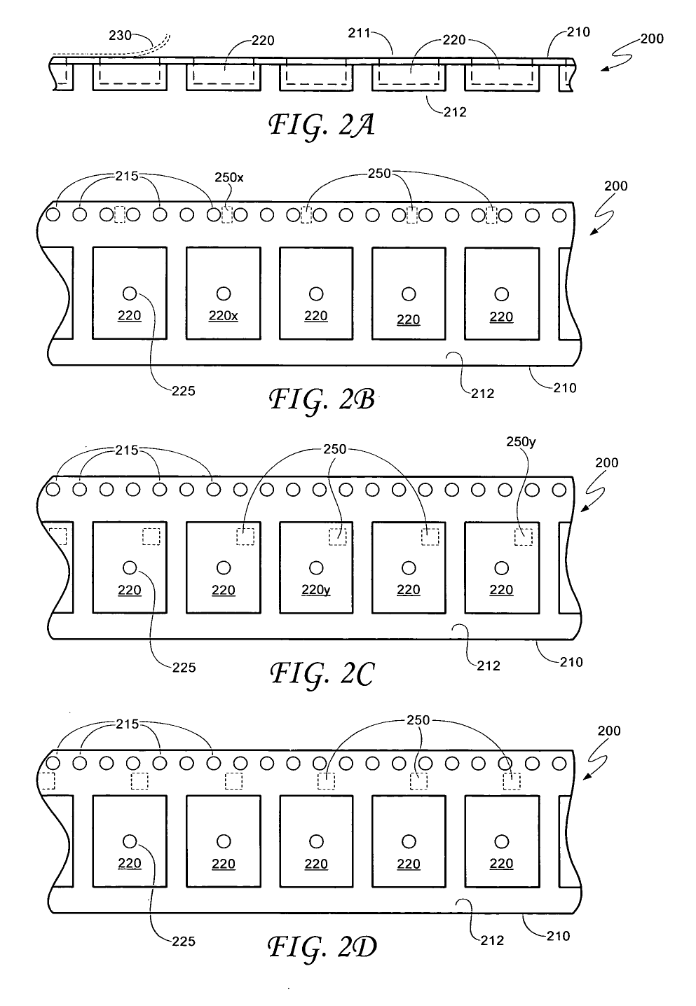

Turning to FIG. 2A and 2D, the carrier tape 200 is illustrated in greater detail. An elevation view of a section of the carrier tape 200 is shown in FIG. 2A, whereas a bottom plan view of the section of carrier tape is shown in each of FIGS. 2B through 2D.

With reference first to FIGS. 2A and 2B, in one embodiment, the carrier tape 200 comprises base 210 having an upper side 211 and an opposing lower side 212. Disposed on the base 210 is a row of evenly-spaced pockets 220. Although a single row of pockets 220 is shown in the figures, in other embodiments, multiple rows of pockets may be distributed along the length of the carrier tape 200. Each of the pockets 220 provides a recess accessible from the upper side 211, and this recess can receive a semiconductor die (or, alternatively, a packaged die or a die assembly). An aperture 225 at the bottom of each pocket 220 may allow for insertion of a pin to assist in extraction of any die placed in a pocket 220. Disposed along one edge (or, perhaps, both edges) of the base 210 is a row of indexing holes 215. A drive gear having teeth adapted to engage the indexing holes 215, or other mechanism capable of engaging the indexing holes, can be used to advance the carrier tape 200 (either alone or in combination with motion of the take-up reel 120). The carrier tape 200 may be constructed from any suitable flexible material, such as a plastic material (e.g., polycarbonate). Also, a flexible cover tape 230 (shown in dashed line in FIG. 2A) may be adhered to the base 210, the cover tape 230 both retaining die within the pockets 220 and protecting the die. The cover tape 230 may be peeled away to remove die from the pockets 220 of the carrier tape.

Carrier tape 200 further includes a number of marks 250, each mark associated with one of the pockets 220. The marks 250 may be disposed at any suitable locations on the carrier tape 200. In one embodiment, the marks 250 are placed on the lower side 212 of base 210. For example, in one embodiment, which is shown in FIG. 2B, the marks 250 may be positioned along an edge of the base 210 and disposed between adjacent indexing holes 215. In another embodiment, as shown in FIG. 2C, the marks 250 may be disposed on the undersides of the pockets 220, and in a further embodiment, the marks 250 may be disposed between the indexing holes 215 and the pockets 220, as shown in FIG. 2D. It should be understood, however, that FIGS. 2B through 2D illustrate but a few examples of possible locations for the marks 250 and, further, that these marks may be disposed on the carrier tape 200 at any suitable locations. For example, the marks 250 could be placed at other locations on the lower side 212 of the carrier tape 200, or the marks 250 could be placed at locations on the upper side 211 of the carrier tape (e.g., at the bottom of each pocket 220). Alternatively, the marks 250 may be disposed on the cover tape 230.

Each of the marks is associated with one of the pockets 220, as noted above. For example, referring to FIG. 2B, mark 250x is associated with pocket 220x. However, it is not necessary that a pocket's associated mark be positioned next to that pocket. By way of example, a mark may “lead” its associated pocket, as illustrated in FIG. 2C, where mark 250y is associated with pocket 220y. The mark 250 associated with any given pocket 220 will be used to correlate a die placed in the pocket with the die's location on the wafer from which the die was cut, as will be explained below in more detail. Should the carrier tape 200 include multiple rows of pockets, each pocket of each row may have an associated mark. Also, in yet another embodiment, not every pocket 220 of the carrier tape 200 has an associated mark 250. Rather, a mark 250 is disposed on the carrier tape 200 for every N^{th} pocket 220 (e.g., every 10^{th} pocket).

The marks 250 may each comprise any suitable symbol or character, or set of symbols and/or characters, that is capable of being read. In one embodiment, the marks 250 are readable by an optical device. Examples of a mark which may be read by an optical device include a bar code, a two-dimensional matrix (e.g., a dot matrix), an alpha and/or numerical character (or characters), a binary number or character, or any other optically readable symbol (or symbols). However, it should be understood that the disclosed embodiments are not limited to optically readable marks and, further, that other types of marks may be employed (e.g., a tag readable by a radio frequency device, a human-readable mark, etc.). Also, the marks 250 may be formed on the carrier tape by any suitable technique, including laser marking, ink marking, dot pinging, embossing, as well as others techniques.

In one embodiment, each of the marks 250 is randomly generated. For example, a mark may comprise a randomly generated number or any other randomly generated symbol or set of symbols (whether expressed in alpha/numerical form, bar code form, matrix form, etc.). In other embodiments, however, the marks 250 may have a sequential order along the length of the carrier tape 200, or the marks 250 may adhere to some other pattern.

At this juncture, it should be noted that the disclosed embodiments are not limited to the use of carrier tape and, further, that the disclosed embodiments may find application to other types of carrier media. For example, semiconductor die may be carried in trays, gel packs, “jewel boxes”, as well as other forms of carrier media. These other forms of carrier media may include marks, or be marked, in accordance with the disclosed embodiments, such that unit level traceability can be performed.

Returning now to FIG. 1, the system 100 also includes a pick-and-place mechanism 150. Pick-and-place mechanism 150 “picks” individual die 390 from a wafer 300 that has been diced or singulated into a number of die. Wafer 300 is held by a wafer holding device 140 (e.g., a wafer chuck, an adhesive tape disposed on a substrate, etc.).

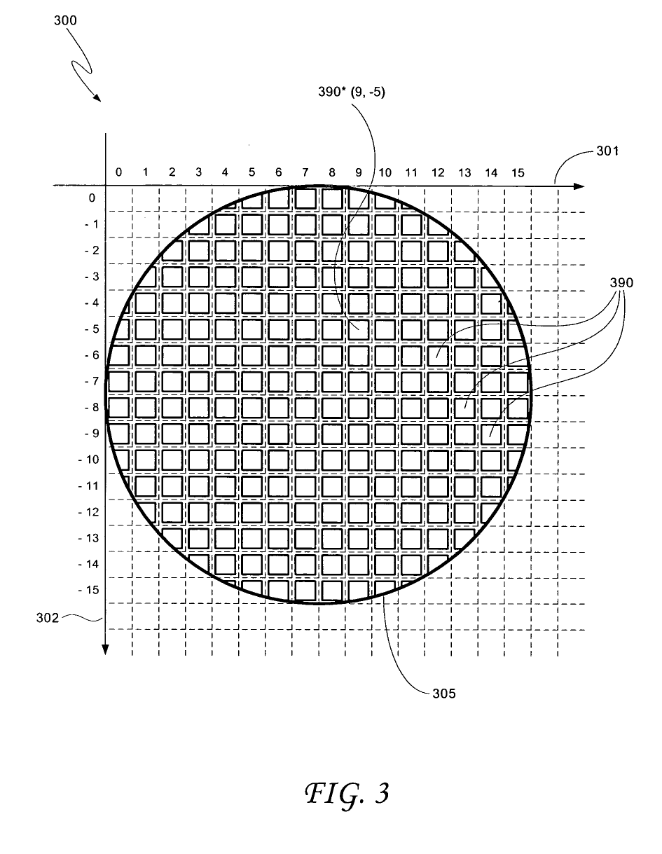

With reference to FIG. 3, wafer 300 is illustrated in greater detail. The wafer 300 comprises a substrate 305 (e.g., Si, Silicon-on-Insulator, GaAs, etc.) upon which integrated circuitry for a number of the die 390 has been formed, and the wafer 300 has been cut into these separate die 390. Each of the die can be viewed as occupying a position within a coordinate system associated with the wafer 300. By way of example, in the embodiment of FIG. 3, a Cartesian coordinate system may be associated with the wafer 300. In FIG. 3, the Cartesian coordinate system is defined by an X-axis 301 and a Y-axis 302, and the wafer 300 occupies the fourth quadrant of the coordinate system. Thus, each die 390 has an associated X-coordinate and an associated Y-coordinate. For example, the die 390* has the X, Y coordinates (9, −5). The reader will appreciate that wafer 300 may occupy any other quadrant (or quadrants) of a Cartesian coordinate system and, further, that wafer 300 may occupy any arbitrary location within the coordinate system (e.g., the center of the wafer may be positioned at 0, 0). Also, it should be understood that any other suitable coordinate system may be utilized (e.g., a polar coordinate system, etc.).

Referring again to FIG. 1, the system 100 further includes a reading device 160. As the carrier tape 200 advances (see arrow), reading device 160 may read the mark associated with each pocket. When a mark associated with a pocket has been read and a die 390 from wafer 300 placed in this pocket by pick-and-place mechanism 150 (which may be done either before or after reading of the mark), the mark may then be correlated with the wafer position (e.g., X-Y coordinates) of the die placed in that pocket, as will be described below in more detail. In one embodiment, the reading device 160 comprises an optical reading device. For example, the reading device 160 may comprise a bar code scanner, a scanner capable of reading a two-dimensional matrix, or an image recognition device. It should be understood, however, that the disclosed embodiments are not limited to use of optical reading devices. For example, the reading device 160 may comprise a radio frequency (RF) device capable of reading an RF tag disposed on (or formed within) the carrier tape 200.

System 100 may also include a controller 400 and a database 170. Controller 400 may be communicatively coupled with the pick-and-place mechanism 150 and the reading device 160, and each of these devices may send signals to controller and receive signals from the controller (and perform actions in response to signals received from the controller). For each die 390, the controller 400 may receive from pick-and-place mechanism 150 the wafer position data (e.g., X-Y coordinates) for the die, and the controller 400 may further receive from the reading device 160 the mark 250 associated with the pocket 220 of carrier tape 200 in which the die will be placed. The controller 400 may then correlate the wafer position with the mark, and this correlation data may be stored in database 170. This correlation data provides unit level traceability (ULT) for any die 390 cut from wafer 300, and this data may be used for failure analysis, process control and verification, quality assurance, as well as other purposes. In addition, the carrier tape mechanism 105 (e.g., actuator 130) may also be communicatively coupled with the controller 400, and the carrier tape mechanism may send signals to controller and receive signals from the controller (and perform actions in response to signals received from the controller).

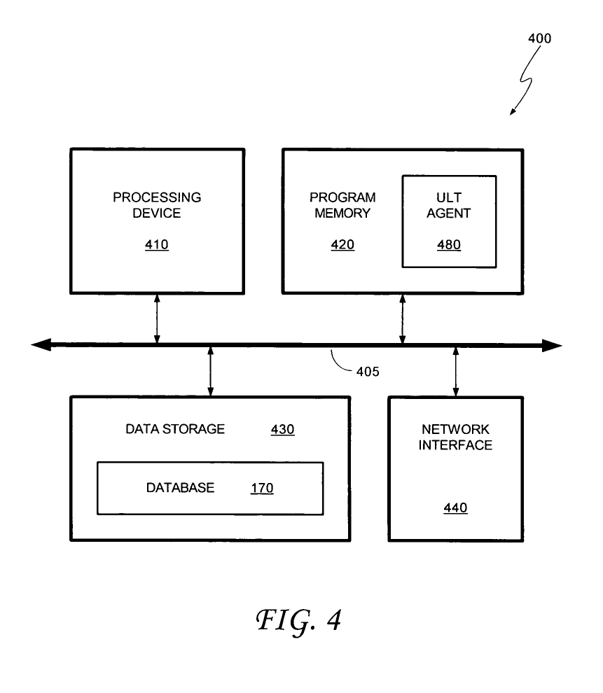

In one embodiment, the controller 400 comprises any suitable computing device, and unit level traceability is performed (at least in part) by a software application that is implemented or executed on this computing device. An embodiment of such a controller is illustrated in FIG. 4.

Referring to FIG. 4, the controller 400 includes a bus 405 to which various components are coupled. Bus 405 is intended to represent a collection of one or more buses—e.g., a system bus, a Peripheral Component Interface (PCI) bus, a Small Computer System Interface (SCSI) bus, etc.—that interconnect the components of controller 400. Representation of these buses as a single bus 405 is provided for ease of understanding, and it should be understood that the controller 400 is not so limited. Those of ordinary skill in the art will appreciate that the controller 400 may have any suitable bus architecture and may include any number and combination of buses.

Coupled with bus 405 is a processing device (or devices) 410. The processing device 410 may comprise any suitable processing device or system, including a microprocessor, an application specific integrated circuit (ASIC), a field programmable gate array (FPGA), etc.

Also coupled with the bus 405 is program memory 420. In one embodiment, unit level traceability is performed (at least in part) by a software routine comprising a set of instructions—e.g., a ULT agent 480—and these instructions may be stored in the program memory 420. Upon system initialization and/or power up, the instructions may be transferred to on-chip memory of the processing device 410, where they are stored for execution on the processing device. The program memory may comprise any suitable non-volatile memory. In one embodiment, the program memory 420 comprises a read-only memory (ROM) device or a flash memory device. In another embodiment, the controller 400 further includes a hard-disk drive (not shown in figures) upon which the ULT agent 480 may be stored. In yet another embodiment, the controller 400 also includes a device (not shown in figures) for accessing removable storage media—e.g., a floppy-disk drive, a CD-ROM drive, and the like—and the ULT agent is downloaded from a removable storage media into memory of the processing device 410 (and/or downloaded into the program memory 420).

In one embodiment, the controller 400 also includes data storage device 430, which is coupled with bus 405. The data storage device 430 may comprise any suitable type and/or number of memory devices. In one embodiment, the data storage device comprises a non-volatile memory, such as a hard-disk drive. In another embodiment, the data storage device comprises a DRAM (dynamic random access memory), a SDRAM (synchronous DRAM), a DDRDRAM (double data rate DRAM), and/or a SRAM (static random access memory). According to one embodiment, during operation of controller 400, the database 170 is contained in the data storage device 430. In another embodiment, however, the database 170 may be stored in a memory external to controller 400.

The controller 400 may, in one embodiment, further comprise a network interface 440 coupled with bus 405. The network interface 440 comprises any suitable hardware, software, or combination of hardware and software that is capable of coupling the controller 400 with a network (or networks) over any suitable communication media (e.g., copper wire, fiber optic, wireless, etc.) using any suitable protocol, such as TCP/IP (Transmission Control Protocol/Internet Protocol), HTTP (Hyper-Text Transmission Protocol), etc. In a further embodiment, upon power up or initialization of the controller 400, the ULT agent 480 is downloaded from a network node via the network interface 440 and stored in a memory of the processing device 410 (and/or program memory 420). In yet another embodiment, the database 170 is maintained on a network node and is accessed via the network interface 440.

It should be understood that the controller 400 illustrated in FIG. 4 is intended to represent an exemplary embodiment of such a device and, further, that this controller may include many additional components, which have been omitted for clarity and ease of understanding. By way of example, the controller 400 may include a chip set associated with the processing device 410, additional memory (e.g., a cache memory), one or more input devices (e.g., a keyboard, a pointing device such as a mouse, and a scanner or other data entry device), one or more output devices (e.g., a video monitor or an audio output device), as well as additional signal lines and buses. The controller 400 may also include a hard-disk drive and/or a device for accessing removable storage media, both as noted above. Also, it should be understood that the controller 400 may not include all of the components shown in FIG. 4 (e.g., any one or more of the program memory 420, data storage device 430, and network interface 440 may be omitted).

In one embodiment, the ULT agent 480 comprises a set of instructions (e.g., a software application) run on a computing device—e.g., the controller illustrated in FIG. 4 or other suitable computing device—as noted above. The set of instructions may be stored locally in program memory 420 or, in another embodiment, the instructions may be stored in a remote storage device and accessed via the network interface 440. The set of instructions may be downloaded from the program memory, or the remote storage media, and stored on the processing device 410 for execution. In a further embodiment, the ULT agent 480 comprises a set of instructions stored on a machine accessible medium, such as, for example, a magnetic media (e.g., a floppy disk or magnetic tape), an optically accessible disk (e.g., a CD-ROM disk), a flash memory device, etc. To execute ULT agent 480 on controller 400, a device for accessing removable storage media may access the instructions on the machine accessible medium, and the instructions may then be downloaded to processing device 410 and executed, as also noted above.

In yet a further embodiment, the ULT agent 480 is implemented in hardware or a combination of hardware and software (e.g., firmware). For example, the ULT agent 480 may be implemented in an ASIC, an FPGA, or other similar device that has been programmed in accordance with the disclosed embodiments.

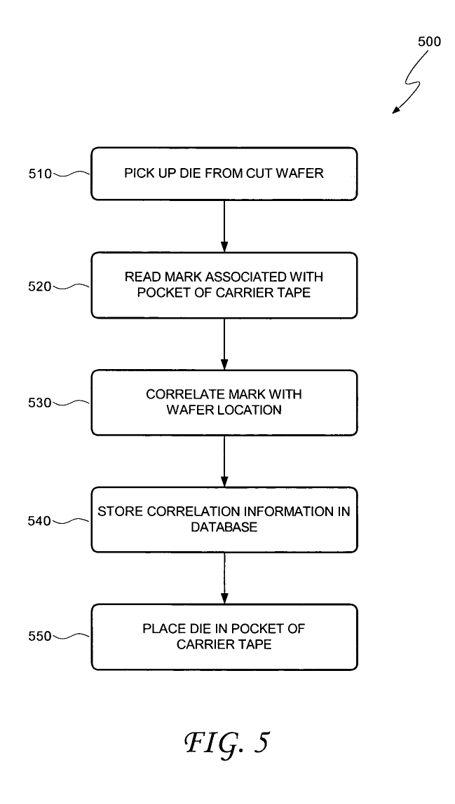

Turning now to FIG. 5, illustrated is an embodiment of a method of providing unit level traceability, as may be performed by the system 100 described in FIGS. 1 through 4 and the accompanying text above. Referring first to block 510, a die is picked from a diced wafer. For example, referring back to FIG. 1, a die 390 of diced wafer 300 may be picked up using pick-and-place mechanism 150. This die has an associated location the wafer (e.g., an X-coordinate and a Y-coordinate).

As set forth in block 520, a mark associated with a pocket of the carrier tape is read. For example, with reference to FIGS. 1 and 2A-2D, a mark 250 associated with a pocket 20 on carrier tape 200 may be read by reading device 160. In one embodiment, the mark 250 is an optically readable mark, and the reading device 160 comprises an optical reading device, as previously noted.

The mark read from the carrier tape is then correlated with the wafer position of the die that was picked from the wafer, which is set forth in block 530. For example, the mark may be correlated with X-Y coordinates of the die. In practice, a symbol or set of symbols—e.g., a randomly generated set of symbols, such as “73AVQ#3F”—may be correlated with a set of coordinates—e.g., (9, −5), as shown in FIG. 3. Again, the mark may be expressed in any readable format—such as in alpha/numerical form, a bar code, or two dimensional matrix—and the mark may not be randomly generated.

Referring to block 540, for the die picked from the wafer, the correlation information is stored. For example, a correlation between the read mark and the wafer location of the die maybe stored in database 170. As set forth in block 550, the die is then placed in the associated pocket of the carrier tape. For example, with reference again to FIG. 1, the pick-and-place mechanism 150 may position the die within a pocket 220 of carrier tape 200 (e.g., that pocket associated with the mark 250 previously read from the carrier tape).

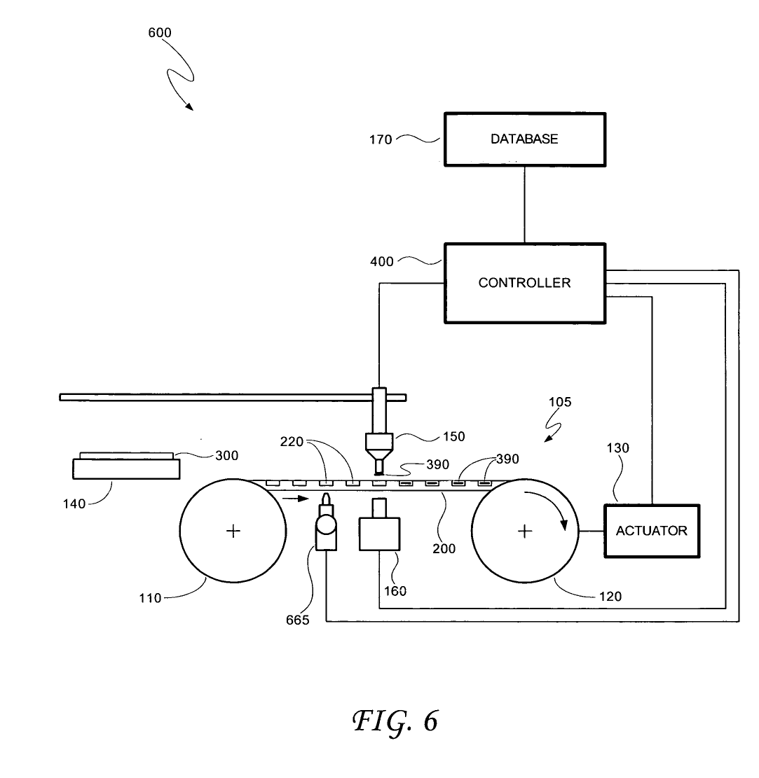

Turning now to FIG. 6, illustrated is another embodiment of a system 600 which can provide unit level traceability for a number of semiconductor die that have been singulated from a wafer. The system 600 of FIG. 6 is similar to the system 100 of FIG. 1, and like elements have retained the same numerical designation in FIG. 6. Further, descriptions of like elements shown FIG. 6, which were described above with respect to FIG. 1, are not repeated in the following text.

As just noted, the system 600 is similar to the system 100 described above. However, the system 600 also includes a marking device 665. The marking device 665 comprises any device which is capable of forming a mark on the carrier tape 200. For example, the marking device 665 may comprise a laser marking device, an ink marking device, a dot pinging device, or an embossing device. In the embodiments described above in FIGS. 1 through 5 and the accompanying text, it was assumed that the carrier tape 200 was “pre-marked” with a number of marks 250, one mark associated with each of the pockets 220. However, in another embodiment, the carrier tape 200 may not include marks associated with the pockets, and the system 600 may be utilized to form marks on the carrier tape 200 for unit level traceability. The marking device 665 may be communicatively coupled with the controller 400, and the marking device may send signals to controller and receive signals from the controller (and perform actions in response to signals received from the controller).

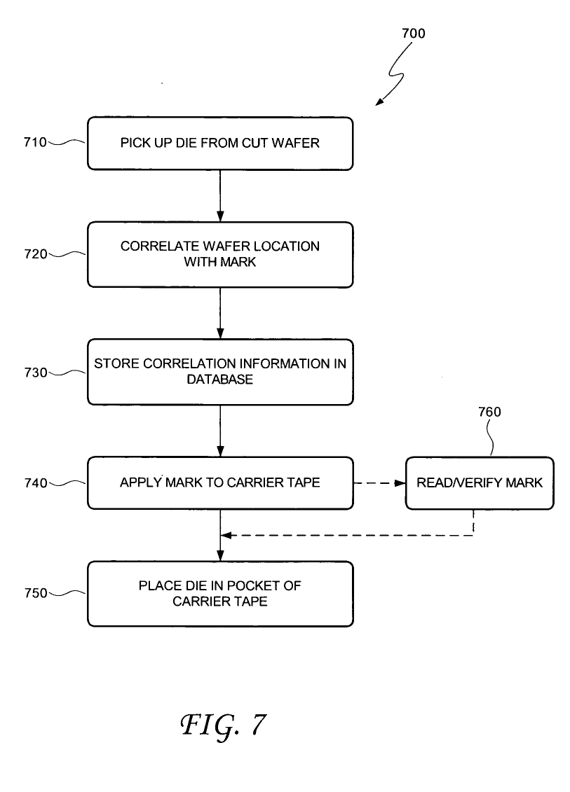

Turning now to FIG. 7, illustrated is an embodiment of a method 700 of providing unit level traceability, as may be performed by the system 600 described in FIG. 6 and the accompanying text above. Referring first to block 710, a die is picked from a diced wafer. Again, for example, referring back to FIG. 1, a die 390 of diced wafer 300 may be picked up using pick-and-place mechanism 150. This die has an associated location on the wafer (e.g., an X-coordinate and a Y-coordinate).

The wafer location of the die is then correlated with a mark, as set forth in block 720. For example, the X-Y coordinates of the die (e.g., “9, −5”, as shown in FIG. 3) may be associated with a mark (which, in practice, may comprise a randomly generated set of symbols, such as “73AVQ#3F”). Once again, the mark may comprise any readable media (e.g., alpha/numerical characters, a bar code, or two-dimensional matrix). Also, as previously suggested, the mark may not be randomly generated.

Referring to block 730, the correlation information for the die may be stored. By way of example, a correlation between the wafer location and the mark may be stored in database 170.

As set forth in block 740, the mark is applied to the carrier tape. The mark may be applied at a location adjacent to the mark's associated pocket of the carrier tape, or the mark may be applied at a distant location with respect to the associated pocket. Also, as previously noted, rather than forming a mark on the carrier tape for every pocket, a mark associated with multiple pockets may be formed on the carrier tape (e.g., a marked may be formed on the carrier tape for every N^{th} pocket). The mark may be formed using any suitable technique, such as laser marking, ink marking, dot pinging, or embossing, and the mark may comprise any symbol or set of symbols (e.g., a combination of alpha and/or numerical characters, a binary representation, a bar code, a two-dimensional matrix, etc.). In one embodiment, the mark is optically readable. Note that the mark may be applied to the carrier tape either before or after placement of the die on the carrier tape.

As set forth in block 750, the die is then stored in the associated pocket of the carrier tape (e.g., that pocket associated with the mark previously formed on the carrier tape). In another embodiment, prior to (or after) placement of the die in the associated pocket of the carrier tape, the mark is read to verify that the mark is correct and/or readable, as set forth in block 760. For example, the mark may be read by reading device 160. Note that, where reading and verification of the mark are not performed, the reading device 160 shown in FIG. 6 may be unnecessary.

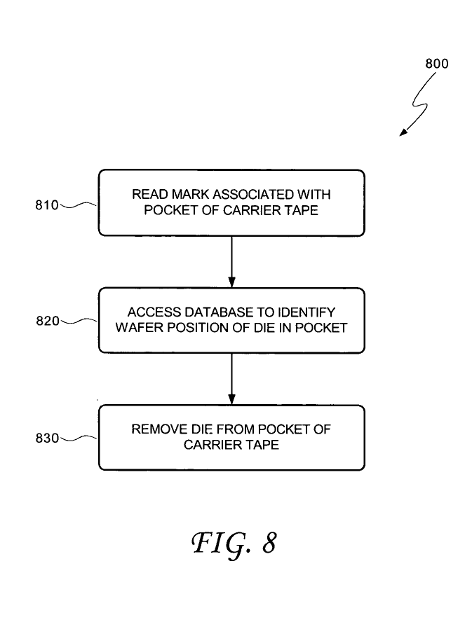

Referring now to FIG. 8, illustrated is an embodiment of a method 800 for tracing a die to its wafer location. As set forth in block 810, a mark associated with a pocket of a carrier tape is read. A correlation database is then accessed to identify the wafer location of the die retained in that pocket, which is set forth in block 820. In a further embodiment, as shown in block 830, the die may be removed from the pocket of the carrier tape (e.g., the die corresponding to the wafer location previously identified). In another embodiment, where every Nth pocket of the carrier tape is marked (rather than every pocket), the number of pockets and/or die may be counted, and should the read mark fail to correspond with the count, an error signal may be triggered.

Note that the method illustrated in FIG. 8 may be performed on a system similar to that shown in FIG. 1. However, the tape reel 110 includes a length of carrier tape 200 upon which a number of die have been disposed, and the die may be removed from the carrier tape 200 (by pick-and-place mechanism 150) as the carrier tape is advanced and wound-onto the take-up reel 120.

The foregoing detailed description and accompanying drawings are only illustrative and not restrictive. They have been provided primarily for a clear and comprehensive understanding of the disclosed embodiments and no unnecessary limitations are to be understood therefrom. Numerous additions, deletions, and modifications to the embodiments described herein, as well as alternative arrangements, may be devised by those skilled in the art without departing from the spirit of the disclosed embodiments and the scope of the appended claims.

1. A method comprising:
reading a mark from a carrier tape, the mark associated with a pocket of the carrier tape;
correlating the mark with a wafer location of a die; and
placing the die in the associated pocket of the carrier tape.

2. The method of claim 1, further comprising storing data representing the correlation between the mark and the wafer location in a database.

3. The method of claim 1, wherein the mark comprises an optically readable mark.

4. The method of claim 1, wherein the information represented by the mark is randomly generated.

5. The method of claim 1, wherein the mark is disposed on a cover tape adhered to the carrier tape.

6. A method comprising:
receiving data from a reading device, the data corresponding to a mark read from a carrier tape, the mark associated with a pocket of the carrier tape; and
correlating the mark with a wafer location of a die that is to be placed in the associated pocket.

7. The method of claim 6, further comprising providing a signal to a pick-and-place mechanism, the pick-and-place mechanism to position the die in the associated pocket of the carrier tape in response to the signal.

8. The method of claim 6, further comprising storing data in a database, the data representing the correlation between the mark and the wafer location.

9. A system comprising:
a mechanism to advance a carrier tape, the carrier tape including a number of pockets and a number of marks, each of the marks associated with one of the pockets;
a reading device to read the marks on the carrier tape, and
a controller, the controller to correlate the mark read from a pocket of the carrier tape with a wafer location of a die that is to be placed in the pocket.

10. The system of claim 9, further comprising a memory coupled with the controller, the memory to store data representing the correlation between the mark and the wafer location.

11. The system of claim 9, further comprising a pick-and-place mechanism to transfer die from a singulated wafer to the carrier tape.

12. The system of claim 9, wherein the reading device comprises an optical reading device and each of the marks comprises an optically readable mark.

13. The system of claim 9, wherein the information represented by the mark is randomly generated.

14. An article of manufacture comprising:
a machine accessible medium providing content that, when accessed by a machine, causes the machine to
receive data from a reading device, the data corresponding to a mark read from a carrier tape, the mark associated with a pocket of the carrier tape; and
correlate the mark with a wafer location of a die that is to be placed in the associated pocket.

15. The article of manufacture of claim 14, wherein the content, when accessed, further causes the machine to provide a signal to a pick-and-place mechanism, the pick-and-place mechanism to position the die in the associated pocket of the carrier tape in response to the signal.

16. The article of manufacture of claim 14, wherein the content, when accessed, further causes the machine to store data in a database, the data representing the correlation between the mark and the wafer location.

17. A method comprising:
correlating a mark with a wafer location of a die;
applying the mark to a carrier tape, the mark associated with a pocket of the carrier tape; and
placing the die in the associated pocket of the carrier tape.

18. The method of claim 17, further comprising reading the mark.

19. The method of claim 17, further comprising storing data representing the correlation between the mark and the wafer location in a database.

20. The method of claim 17, wherein the mark comprises an optically readable mark.

21. The method of claim 17, wherein the information represented by the mark is randomly generated.

22. The method of claim 17, wherein the mark is applied to a cover tape adhered to the carrier tape.

23. A method comprising:
receiving data corresponding to a wafer location of a die;
correlating the wafer location data with a mark; and
providing a signal to a marking device, the marking device to apply the mark to a carrier tape in response to the signal, wherein the mark is associated with a pocket of the carrier tape that is to receive the die.

24. The method of claim 23, further comprising providing a signal to a pick-and-place mechanism, the pick-and-place mechanism to position the die in the associated pocket of the carrier tape in response to the signal.

25. The method of claim 23, further comprising receiving data from a reading device, the data corresponding to the mark applied to the carrier tape.

26. The method of claim 23, further comprising storing data in a database, the data representing the correlation between the mark and the wafer location.

27. A system comprising:
a mechanism to advance a carrier tape, the carrier tape including a number of pockets;
a controller, the controller to correlate a mark with a wafer location of a die; and
a marking device to apply the mark to the carrier tape, the mark associated with one of the pockets that is to receive the die.

28. The system of claim 27, further comprising a memory coupled with the controller, the memory to store data representing the correlation between the mark and the wafer location.

29. The system of claim 27, further comprising a pick-and-place mechanism to transfer die from a singulated wafer to the carrier tape.

30. The system of claim 27, further comprising a reading device to read the mark applied to the carrier tape.

31. The system of claim 30, wherein the reading device comprises an optical reading device and the mark comprises an optically readable mark.

32. The system of claim 27, wherein the information represented by the mark is randomly generated.

33. An article of manufacture comprising:
a machine accessible medium providing content that, when accessed by a machine, causes the machine to
receive data corresponding to a wafer location of a die;
correlate the wafer location data with a mark; and
provide a signal to a marking device, the marking device to apply the mark to a carrier tape in response to the signal, wherein the mark is associated with a pocket of the carrier tape that is to receive the die.

34. The article of manufacture of claim 33, wherein the content, when accessed, further causes the machine to provide a signal to a pick-and-place mechanism, the pick-and-place mechanism to position the die in the associated pocket of the carrier tape in response to the signal.

35. The article of manufacture of claim 33, wherein the content, when accessed, further causes the machine to receive data from a reading device, the data corresponding to the mark applied to the carrier tape.

36. The article of manufacture of claim 33, wherein the content, when accessed, further causes the machine to store data in a database, the data representing the correlation between the mark and the wafer location.
